(19) United States
(12) Patent Application Publication
(10) Pub. No.: US 2018/0140063 A1
(43) Pub. Date: May 24, 2018

(54) CELL PHONE POCKET/SHIELD

(71) Applicant: Jose Gomez, Anaheim, CA (US)

(72) Inventor: Jose Gomez, Anaheim, CA (US)

(21) Appl. No.: 15/821,434

(22) Filed: Nov. 22, 2017

Related U.S. Application Data
(60) Provisional application No. 62/425,837, filed on Nov. 23, 2016.

(51) Int. Cl. A45C 1/08; A45C 1/04; A45C 13/10; A45C 11/00; A45F 5/02; H04B 1/3827

(52) U.S. Cl. CPC A45C 1/08; A45C 1/04; A45C 13/103; A45C 11/00; A45F 2200/0516; H04B 1/3838; A45C 2013/1015; A45C 2001/086; A45C 2011/002; A45F 5/021

(57) ABSTRACT

An improved carrying case adapted to releasably retain items within the interior volume of the pocket, prevent radio waves from entering the interior volume and unauthorized access to one's phone and credit cards, and help block signal saturation to the skin and body, while maintaining the integrity of the equipment.

### CROSS-REFERENCE TO RELATED APPLICATION

The present application is related to and claims priority from prior provisional application Ser. No. 62/425,837, filed Nov. 23, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of protective cases and more specifically relates to an improved carrying case. adapted to releasably retain items within said interior volume of the pocket, prevent radio waves from entering the interior volume and unauthorized access to one's phone and credit cards, and help block signal saturation to the skin and body, while maintaining the integrity of the equipment.

### 2. DESCRIPTION OF THE RELATED ART

Identity theft is America's fastest-growing crime. Last year alone, more than 17 million Americans were victims of identity theft—a 41 percent increase over the year before—at a cost to the U.S. economy of roughly 53 billion. In reality, the number of identity theft victims and the economic impact of the various crimes involved, from mail theft to Internet fraud, were probably even higher. And as identity thieves find new ways of stealing people's identifying information and new ways of abusing it, these crimes are expected to proliferate at an even faster rate.

While it is commonly assumed that the current fraud epidemic has its roots online, in fact, identity theft often begins with mail theft: letters and packages stolen from unlocked or unprotected mailboxes—often placed along rural or suburban roads or grouped in front of apartment buildings, where access is easy and oversight is nil. For an identity thief, the haul can be substantial: credit cards, driver's licenses, bank statements, boxes of unused checks, Social Security payments, health insurance cards, tax information, and other sensitive data. Unfortunately, victims of identity theft in such a manner are unaware of the thievery until it is too late. Notification typically does not occur until a financial institution contacts a customer to inquire about possible suspicious activity on their accounts, or to collect a debt the client has no knowledge of ever incurring. At this point, the victim has likely lost countless dollars and suffered a serious setback in his or her financial reputation that it could take months, or even years, to resolve.

Various attempts have been made to solve problems found in cases art. Among these are found in: U.S. Publication No. 2014/0252054 to Yu Long Zhang; U.S. Publication No. 2014/0203020 to Marc Trombino; and U.S. Publication No. 2012/0067751 to Ryan Hill Mongan, et al. This prior art is representative of protective cases for mobile devices.

Ideally, an Improved Carrying Case should be user-friendly and safe in-use and, yet should operate reliably and be manufactured at a modest expense. Thus, a need exists for an improved carrying case. adapted to releasably retain items within said interior volume of the pocket, prevent radio waves from entering the interior volume and unauthorized access to one's phone and credit cards, and help block signal saturation to the skin and body, while maintaining the integrity of the equipment and to avoid the above-mentioned problems.

### BRIEF SUMMARY OF THE INVENTION

In view of the foregoing disadvantages inherent in the known protective cases device art, the present invention provides an Improved Carrying Case (entitled Cell Phone Pocket/Shield). The general purpose of the present invention, which will be described subsequently in greater detail is to provide an Improved Carrying Case. adapted to releasably retain items within said interior volume of the pocket, prevent radio waves from entering the interior volume and unauthorized access to one's phone and credit cards, and help block signal saturation to the skin and body, while maintaining the integrity of the equipment.

An improved carrying case comprises a main body and an adjustable strap member. The main body includes a first side panel, a second side panel. The first side panel is formed from a material adapted to block radio waves. The second side panel is formed from a material adapted to block radio waves. The first side panel and said second side panel are connected to one another along a length of respective adjacent edges thereof. The first side panel and the second side panel form an opening between a length of respective adjacent edges thereof. The first side panel and the second side panel form an interior pocket having an interior volume therebetween. The main body is adapted to releasably retain items within the interior volume of the pocket, prevent radio waves from entering the interior volume, and thereby protect the items from the radio waves

The releasable fastener has a first fastener member and a second fastener member. The first fastener member is connected to one of the respective adjacent edges forming the opening. The second fastener member is connected to the other one of the respective adjacent edges forming the opening. The releasable fastener is adapted to releasably retain the respective adjacent edges together to thereby selectively enclose said pocket and releasably retain items within the interior volume.

The adjustable strap member is connected to said main body and is adapted to allow a user to releasably hold said improved carrying case.

The present invention holds significant improvements and serves as an improved carrying case. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Improved Carrying Case (entitled Cell Phone Pocket/Shield), constructed and operative according to the teachings of the present invention.

FIG. 1 shows a perspective view illustrating an improved carrying case according to an embodiment of the present invention.

FIG. 2 is a perspective view illustrating a pocket and a first exterior pocket member of the improved carrying case according to an embodiment of the present invention.

FIG. 3 is a perspective view illustrating a releasable fastener of the improved carrying case according to an embodiment of the present invention of FIG. 1.

FIG. 4 is a perspective view illustrating an adjustable strap member and belt loop member of the improved carrying case according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a protective cases device and more specifically relates to an Improved Carrying Case (entitled Cell Phone Pocket/Shield) adapted to releasably retain items within said interior volume of the pocket, prevent radio waves from entering the interior volume and unauthorized access to one's phone and credit cards, and help block signal saturation to the skin and body, while maintaining the integrity of the equipment.

Generally speaking, the Cell Phone Pocket/Shield comprises a specially designed line of practical, dual purpose casings for cellular smartphones that are specially designed to protect expensive equipment from exposure to potentially damaging elements, while also being lined with a blocking agent that is able to prevent the stealing of information via the radio frequency identification (RFID) tags that are germane to much personal and financial information typically carried in a handbag or pocket.

Fashionable and attractive, each Cell Phone Pocket/Shield would be made available in a wide variety of colors and styles to appeal to personal tastes. Rectangular and featuring a smooth microfiber interior material, the unit would contain a conveniently adjustable strap; belt loop for securing to a favorite belt; an interior pocket appropriate for housing a cell phone, along with items such as credit/debit cards; and an outer pocket for housing identification cards, passports, and cash. Both pockets would feature a three-sided zipper closure for security, and easy access. A standard Cell Phone Pocket/Shield case would measure approximately 6½″ in length, 3½″ in width, and ⅞″ in thickness, with the outer pocket offering dimensions of 4½″ in length, 2¾″ in width, and ⅝″ in thickness.

The Cell Phone Pocket/Shield would be made available in a variety of sizes to accommodate almost any smartphone on the market. Additionally, Cell Phone Pocket/Shield cases would be created for various tablet computer models. Regardless of size, each unit would offer a simulated, leather-based shield which would line the entire exterior of the case, completely shielding every item contained within. As RFID tags can be read from as far as thirty (30) feet away, leaving consumers susceptible to stolen information that can benefit identity thieves, the complete sheathing of the Cell Phone Pocket/Shield would ensure that scanning equipment is effectively thwarted. Since thicker materials such as leather or variations thereof have been found to efficiently block radio waves, the Cell Phone Pocket/Shield's scanning protection would prevent owners from becoming victims of crime. In addition, frequency/signal blocking cards can be inserted in the pockets to block any unauthorized access to one's phone or other contents. This will also help block signal saturation to the skin and body.

A concept such as the Cell Phone Pocket/Shield could revolutionize commerce by providing law-abiding consumers with an effective deterrent to financial and identity theft. As a result, users would be able to go to work, attend to errands, and enjoy recreational shopping excursions without worry that their money, identity, and personal property will fall into the hands of criminals. Featuring convenient scanning protection, the Cell Phone Pocket/Shield would, in addition to guarding against high-tech attempts to swipe the information found on RFID tags, also keep expensive equipment protected from the damage that can be caused by liquids and debris. Snugly ensconced within the confines of the Cell Phone Pocket/Shield, smartphones and tablets would be effectively blocked from flying dust particles that can clog ingress ports, as well as moisture that can compromise delicate electronics, thus, saving consumers money in replacement costs. Ideal for everyday use, the Cell Phone Pocket/Shield would foster peace of mind in users, knowing they will be spared the hours of work and years of anxiety that can come from trying to restore their reputation.

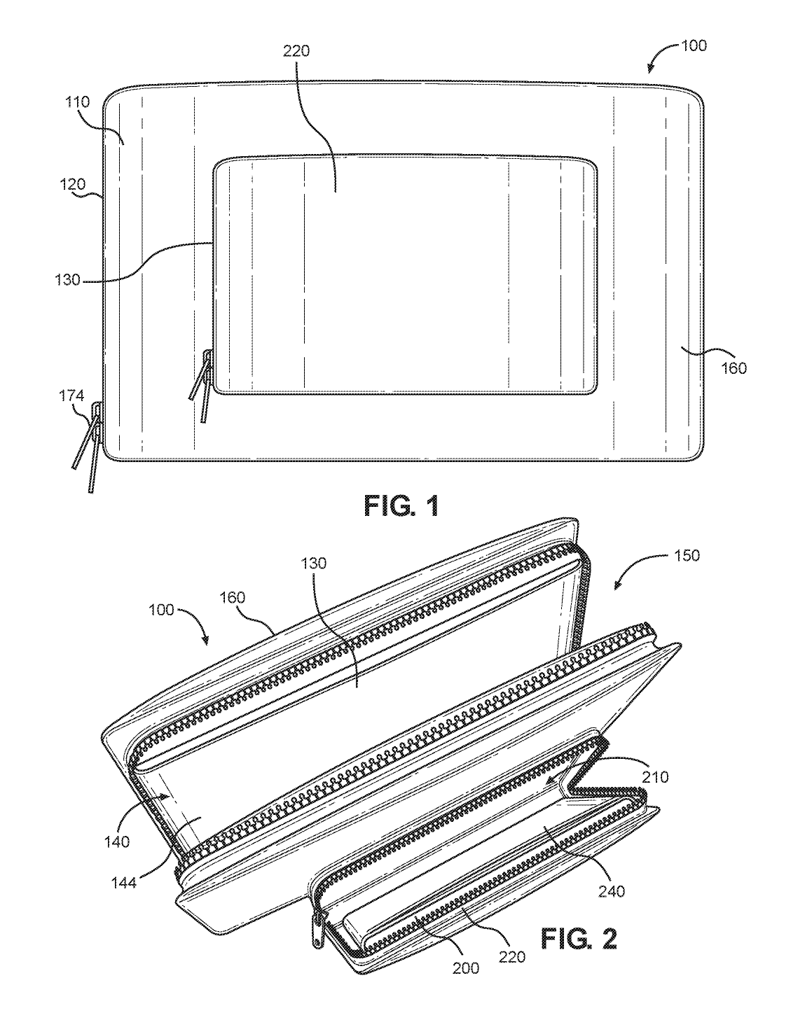

Referring now to FIGS. 1-4, showing perspective views illustrating improved carrying case 100 according to an embodiment of the present invention of FIG. 1

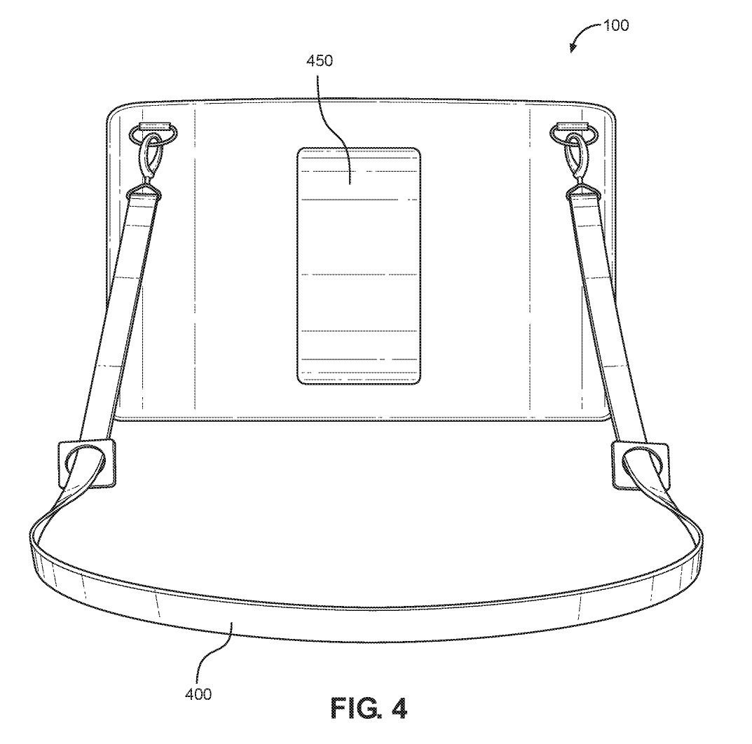

Improved carrying case 100 comprises main body 110 and adjustable strap member 400. Main body 110 includes first side panel 120, second side panel 160, and releasable fastener 170. First side panel 120 is formed from a material adapted to block radio waves. Second side panel 160 is formed from a material adapted to block radio waves. First side panel 120 and second side panel 160 are connected to one another along a length of respective adjacent edges thereof. First side panel 120 and second side panel 160 form opening 150 between a length of respective adjacent edges thereof. First side panel 120 and second side panel 160 are formed from a leather material. Improved carrying case 100 further comprising belt loop member 450 connected to main body 110 and is adapted to allow a user to releasably attach improved carrying case 100 to a belt the user is wearing. Adjustable strap member 400 is connected to main body 110 and is adapted to allow a user to releasably hold improved carrying case 100 as shown in FIG. 4.

Main body 110 is formed having a length of 6½ inches, a width of 3½ inches, and a thickness of ⅞ of an inch. First side panel 120 and second side panel 160 form interior pocket 130 having interior volume 140 therebetween. Main body 110 further includes interior lining 144 located within interior volume 140 and attached to inner walls of first panel 120 and second side panel 160; and wherein interior lining 144 is formed from a microfiber material. The microfiber material is chosen from a group of microfiber materials consisting of cotton, nylon, and silk.

Main body 110 is adapted to releasably retain items within interior volume 140 of pocket 130, prevent radio waves from entering interior volume 140, and thereby protect the items from the radio waves. Improved carrying case 100 further comprises first exterior pocket member 200 attached to an outer surface of one of first panel 130 and second side panel 160 and forms interior volume 210; wherein first exterior pocket member 200 is adapted to releasably house items therein and includes outer panel 220 formed from a material adapted to block radio waves from entering interior volume 210. First exterior pocket member 200 is formed having a length of 4½ inches, a width of 2¾ inches, and a thickness of ⅝ of an inch.

Improved carrying case 100 further comprising at least one radio wave blocking card member 240 adapted to be removably placed within respective first exterior pocket member 200 and adapted to further block and protect items therein from radio waves.

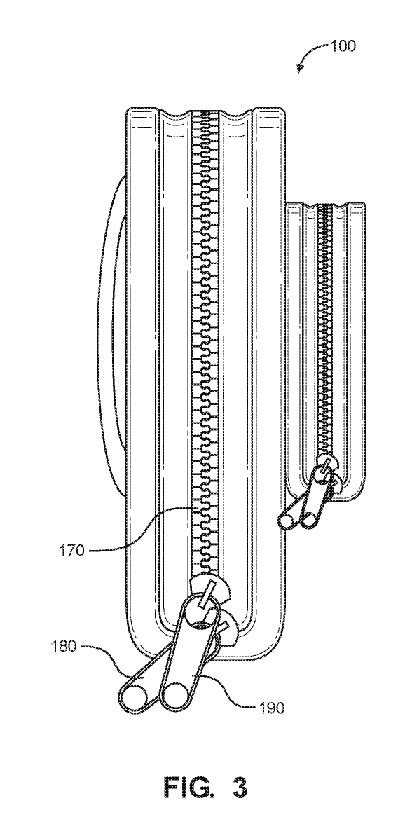

Releasable fastener 170 has first fastener member 180 and second fastener member 190. First fastener member 180 is connected to one of the respective adjacent edges forming opening 150. Second fastener member 190 is connected to the other one of the respective adjacent edges forming opening 150 as shown in FIG. 3. Releasable fastener 170 is adapted to releasably retain the respective adjacent edges together to thereby selectively enclose pocket 130 and releasably retain items within interior volume 140. Releasable fastener 170 is formed as zipper member 174. Zipper member 174 is formed as a three-sided zipper member. Upon reading this specification, it should be appreciated that, under appropriate circumstances, considering such issues as user preferences, design preference, structural requirements, marketing preferences, cost, available materials, technological advances, etc., other releasable fastener arrangements such as, for example, hook and loop material, a hook and latch, etc., may be sufficient

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An improved carrying case comprising:
a main body including:
a first side panel;
wherein said first side panel is formed from a material adapted to block radio waves; and
a second side panel;
wherein said second side panel is formed from a material adapted to block radio waves;
wherein said first side panel and said second side panel are connected to one another along a length of respective adjacent edges thereof;
wherein said first side panel and said second side panel form an opening between a length of respective adjacent edges thereof;
wherein said first side panel and said second side panel form an interior pocket having an interior volume therebetween; and
a releasable fastener including:
a first fastener member;
wherein said first fastener member is connected to one of said respective adjacent edges forming said opening; and
a second fastener member;
wherein said second fastener member is connected to the other one of said respective adjacent edges forming said opening;
wherein said releasable fastener is adapted to releasably retain said respective adjacent edges together to thereby selectively enclose said pocket and releasably retain items within said interior volume;
wherein said main body is adapted to releasably retain items within said interior volume of said pocket, prevent radio waves from entering said interior volume, and thereby protect said items from said radio waves; and
an adjustable strap member;
wherein said adjustable strap member is connected to said main body and is adapted to allow a user to releasably hold said improved carrying case.

2. The improved carrying case of claim 1, wherein said first and second side panels are formed from a leather material.

3. The improved carrying case of claim 1, further comprising a first exterior pocket member attached to an outer surface of one of said first and second side panels and forms an interior volume; wherein first exterior pocket member is adapted to releasably house items therein and includes an outer panel formed from a material adapted to block radio waves from entering said interior volume.

4. The improved carrying case of claim 3, further comprising at least one radio wave blocking card member adapted to be removably placed within respective said first exterior pocket member and adapted to further block and protect items therein from radio waves.

5. The improved carrying case of claim 1, wherein said main body further includes an interior lining located within said interior volume and attached to inner walls of said first and second side panels; and wherein said interior lining is formed from a microfiber material.

6. The improved carrying case of claim 5, wherein said microfiber material is chosen from a group of microfiber materials consisting of cotton, nylon, and silk.

7. The improved carrying case of claim 1, further comprising a belt loop member connected to said main body and is adapted to allow a user to releasably attach said improved carrying case to a belt said user is wearing.

8. The improved carrying case of claim 1, wherein said releasable fastener is formed as a zipper member.

9. The improved carrying case of claim 8, wherein said zipper member is formed as a three-sided zipper member.

10. The improved carrying case of claim 1, wherein said releasable fastener is formed from hook and loop material.

11. The improved carrying case of claim 1, wherein said releasable fastener is formed as a hook and latch.

12. The improved carrying case of claim 1, wherein said main body is formed having a length of 6½ inches, a width of 3½ inches, and a thickness of ⅞ of an inch.

13. The improved carrying case of claim 2, wherein said first exterior pocket member is formed having a length of 4½ inches, a width of 2¾ inches, and a thickness of ⅝ of an inch.
